(19) United States
(12) Patent Application Publication
(10) Pub. No.: US 2026/0098742 A1
(43) Pub. Date: Apr. 9, 2026

(54) Exemplar-Based Road Structure Estimation

(71) Applicant: Nissan North America, Inc., Franklin, TN (US)

(72) Inventors: Christopher Ostafew, Mountain View, CA (US); Hsin-Min Cheng, Millbrae, CA (US)

(21) Appl. No.: 18/908,293

(22) Filed: Oct. 7, 2024

(51) Int. Cl. G01C 21/00; G08G 1/01

(52) U.S. Cl. CPC G01C 21/3815; G08G 1/01

(57) ABSTRACT

A method includes receiving information about vehicles traveling within a vehicle transportation network. The information comprises driveline data and information regarding lanes within the network. The driveline data comprises one or more drivelines representing a position of one of the vehicles as the vehicle traverses the network. The method also includes consolidating all of the information as raw data, delineating an intersection area from the information about the vehicle transportation network, constructing way data from the information about the network, storing intermediate data comprising the information, the intersection area, and the way data, estimating a number of the lanes within the network based on the way data, and inferring a drive location with the lanes based on the way data. The method also includes creating a map that includes the lanes, the drive location within the lanes, and the intersection area within the network.

### TECHNICAL FIELD

This application relates to map and kinematic prediction for vehicles and, more particularly, to exemplar-based road structure estimation and mapping.

### BACKGROUND

For safe and reliable operation, at least some sub-systems in a vehicle may include inherent self-monitoring capabilities, issue detection capabilities, and, if possible, remediation capabilities.

Autonomous vehicles (or more broadly, autonomous driving) offer passengers the convenience of efficient and safe conveyance from one location to another. An autonomous vehicle may plan a trajectory to traverse a portion of a vehicle transportation network based on lane level maps in the absence of real-time perception information of the portion of the vehicle transportation network.

### SUMMARY

Building an accurate lane-level map is expensive and time-consuming. A lane-level map may be formed by estimating geometric center lines relative to lane markings. However, a lane-level map defined by geometric center lines may not represent how people actually drive. However, the system may track how vehicles controlled by people are driven so that additional data points may be generated relative to a road structure and lanes within that road structure. The system may smooth curves or drivelines related to moving through an intersection or turning while driving through an intersection.

The teachings herein describe combining a road-level map and observed drivelines of real-world road users to generate a data-based driveline map in lane-level detail. Such a map may be used for improved determination of a vehicle trajectory and improved operation of a vehicle. The road structures may be modeled based on empirical data, maps, user input, multiple vehicles, multiple data inputs (e.g., sources), or a combination thereof.

A first aspect of the disclosed implementations is a method including: receiving information about vehicles traveling within a vehicle transportation network. The information comprises driveline data and information regarding lanes within the vehicle transportation network. The driveline data comprises one or more drivelines representing a position of one of the vehicles as the vehicle traverses the vehicle transportation network. Consolidating all of the information as raw data. Delineating an intersection area from the information about the vehicle transportation network. Constructing way data from the information about the vehicle transportation network. Storing intermediate data comprising the information, the intersection area, and the way data. Estimating a number of the lanes within the vehicle transportation network based on the way data. Inferring a drive location with the lanes based on the way data. Creating a map that includes the lanes, the drive location within the lanes, and the intersection area within the vehicle transportation network.

A second aspect of the disclosed implementations is an apparatus that includes a memory and a processor. The processor is configured to execute instructions stored in the memory. Receive information about vehicles traveling within a vehicle transportation network. The information comprises driveline data and information regarding lanes within the vehicle transportation network. The driveline data has one or more drivelines representing a position of one of the vehicles as the vehicle traverses the vehicle transportation network. Consolidate all of the information as raw data. Delineate an intersection area from the information about the vehicle transportation network. Construct way data from the information about the vehicle transportation network. Store intermediate data comprising the information, the intersection area, and the way data. Estimate a number of the lanes within the vehicle transportation network based on the way data. Infer a drive location with the lanes based on the way data. Create a map that includes the lanes, the drive location within the lanes, and the intersection area within the vehicle transportation network.

A third aspect of the disclosed implementations is a non-transitory computer-readable medium storing instructions operable to cause one or more processors to perform operations including receive information about vehicles traveling within a vehicle transportation network. The information has driveline data and information regarding lanes within the vehicle transportation network. The driveline data comprises one or more drivelines representing a position of one of the vehicles as the vehicle traverses the vehicle transportation network. Consolidate all of the information as raw data. Delineate an intersection area from the information about the vehicle transportation network. Construct way data from the information about the vehicle transportation network. Store intermediate data comprising the information, the intersection area, and the way data. Estimate a number of the lanes within the vehicle transportation network based on the way data. Infer a drive location with the lanes based on the way data. Create a map that includes the lanes, the drive location within the lanes, and the intersection area within the vehicle transportation network.

Variations in these and other aspects, features, elements, implementations, and embodiments of the methods, apparatus, procedures, and algorithms disclosed herein are described in further detail hereafter.

### BRIEF DESCRIPTION OF THE DRAWINGS

The disclosed technology is best understood from the following detailed description when read in conjunction with the accompanying drawings. It is emphasized that, according to common practice, the various features of the drawings may not be to scale. On the contrary, the dimensions of the various features may be arbitrarily expanded or reduced for clarity. Further, like reference numbers refer to like elements throughout the drawings unless otherwise noted.

FIG. 1 is a diagram of an example of a portion of a vehicle in which the aspects, features, and elements disclosed herein may be implemented.

FIG. 2 is a diagram of an example of a portion of a vehicle transportation and communication system in which the aspects, features, and elements disclosed herein may be implemented.

FIG. 3A are diagrams showing examples of a road-level map.

FIG. 3B is a diagram showing an example of observed drivelines in a portion of a vehicle transportation network.

FIG. 3C is a diagram showing an example of observed drivelines and ways in a portion of a vehicle transportation network.

FIG. 4A is a flowchart of an example of a process for generating a data-based driveline map.

FIG. 4B is a flowchart of an example of a process of estimating a road structure to generate a driving map within a vehicle transportation network.

FIGS. 5A-5C are diagrams of an example of identifying intersections and matching road-level map data with observed driveline data, where FIG. 5A illustrates a portion of road-level map data where more than one way intersect, FIG. 5B illustrates how way bars to ways, and FIG. 5C illustrates the orientation of drivelines from observed driveline data to ways.

FIG. 6 is a diagram of an example of lane count estimation.

FIG. 7A is diagram of an example of assigning link nodes.

FIG. 7B is a diagram of an example of inferring driveline connectivity.

FIG. 8A illustrates a first type of matching.

FIG. 8B illustrates a second type of matching.

FIG. 8C illustrates a third type of matching.

FIG. 9 is a flow diagram illustrating the matching of FIG. 8C.

FIG. 10A illustrates querying data from a database.

FIG. 10B illustrates estimating a lane count based on the query from the database.

FIG. 10C connects poses generated in each lane and based on the query from the database.

FIG. 10D illustrates generating a drive location based on the number of lanes and the query from the database.

### DETAILED DESCRIPTION

A vehicle (which may also be referred to herein as a host vehicle), such as an autonomous vehicle (AV) or a semi-autonomous vehicle, such as a vehicle including an advanced driver-assistance system (ADAS), may autonomously traverse a portion of a vehicle transportation network. Collectively, such vehicles may be referred to as autonomous vehicles.

Traversing the vehicle transportation network may include capturing data, such as data corresponding to an operational environment of the vehicle, or a portion thereof. For example, the data may include data corresponding to one or more external objects (or simply, objects) including other road users (i.e., other than the host vehicle itself), such as other vehicles, bicycles, motorcycles, trucks, etc., that may also be traversing the vehicle transportation network.

A trajectory can be planned (such as by a controller of the host vehicle) based on scene understanding. A scene can include the external objects (e.g., the other road users) around of the host vehicle, including static and dynamic objects. A scene can include data available in a road-level map. The road-level map can include way data. Way data can be one or more ways where a way can be a line of a lane such that a longitudinal axis of a road user traversing the lane can be expected to align with the way. The way can also contain nodes in which each node makes up a point along the way.

Additionally, a scene can also include observed driveline data of at least some of the other road users. The observed driveline data includes one or more drivelines. The drivelines represent the line in which a road user was recorded as having travelled while traversing the vehicle transportation network. The drivelines comprise a series of poses where a pose represents the specific location along the driveline including the direction the road user was heading at the time the pose was recorded. As such, scene understanding can include way data available in road-level maps and observed driveline data of other road users.

Poor or inaccurate lane-level maps may cause the controller of the vehicle to plan sub-optimal or unsafe trajectories for the host vehicle. Inaccurate lane-level maps may occur in several situations. For example, inaccurate lane-level maps may occur when the data in the road-level map is inaccurate or incomplete. For example, inaccurate lane-level maps may occur if the data in the road-level map is accurate, but road users may drive in ways that are not according to the data in the road-level map.

To illustrate, and without loss of generality, a left-turn driveline at an intersection may be accurately mapped; however, a majority of road users may drive past the mapped driveline before turning left at the interaction. It is noted that there can be a wide variance on how drivers make the turn (or confront any other driving situation or driveline). The system may analyze multiple data sources in regards to a turn and may provide a drive line with a width that is increased relative to a typical drive line so that variations in turning locations may be taken into consideration to provide a turning region.

Although described herein with reference to an autonomous host vehicle, the techniques and apparatuses described herein may be implemented in any vehicle capable of autonomous or semi-autonomous operation. The method and apparatus described herein may be used within a vehicle transportation network, which can include any area navigable by a host vehicle.

To describe some implementations of the teachings herein in greater detail, reference is first made to the environment in which this disclosure may be implemented.

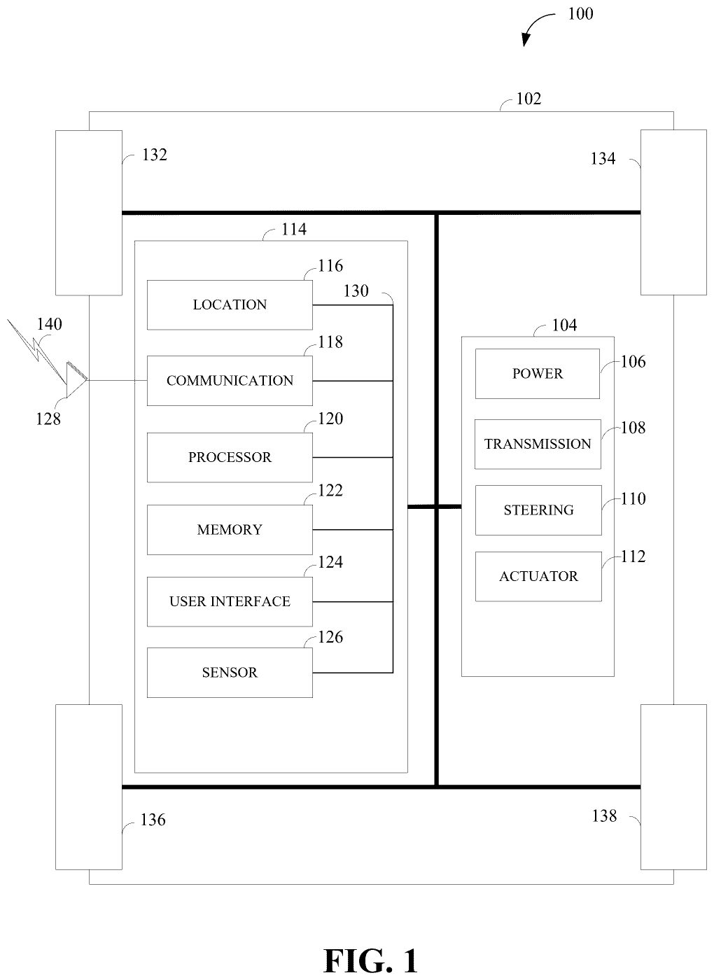

FIG. 1 is a diagram of an example of a portion of a vehicle 100 in which the aspects, features, and elements disclosed herein may be implemented. The vehicle 100 includes a chassis 102, a powertrain 104, a controller 114, wheels 132/134/136/138, and may include any other element or combination of elements of a vehicle. Although the vehicle 100 is shown as including four wheels 132/134/136/138 for simplicity, any other propulsion device or devices, such as a propeller or tread, may be used. In FIG. 1, the lines interconnecting elements, such as the powertrain 104, the controller 114, and the wheels 132/134/136/138, indicate that information, such as data or control signals, power, such as electrical power or torque, or both information and power, may be communicated between the respective elements. For example, the controller 114 may receive power from the powertrain 104 and communicate with the powertrain 104, the wheels 132/134/136/138, or both, to control the vehicle 100, which can include accelerating, decelerating, steering, or otherwise controlling the vehicle 100.

The powertrain 104 includes a power source 106, a transmission 108, a steering unit 110, a vehicle actuator 112, and may include any other element or combination of elements of a powertrain, such as a suspension, a drive shaft, axles, or an exhaust system. Although shown separately, the wheels 132/134/136/138 may be included in the powertrain 104.

The power source 106 may be any device or combination of devices operative to provide energy, such as electrical energy, thermal energy, or kinetic energy. For example, the power source 106 includes an engine, such as an internal combustion engine, an electric motor, or a combination of an internal combustion engine and an electric motor, and the power source 106 is operative to provide kinetic energy as a motive force to one or more of the wheels 132/134/136/138. In some embodiments, the power source 106 includes a potential energy unit, such as one or more dry cell batteries, such as nickel-cadmium (NiCd), nickel-zinc (NiZn), nickel metal hydride (NiMH), lithium-ion (Li-ion); solar cells; fuel cells; or any other device capable of providing energy.

The transmission 108 receives energy, such as kinetic energy, from the power source 106 and transmits the energy to the wheels 132/134/136/138 to provide a motive force. The transmission 108 may be controlled by the controller 114, the vehicle actuator 112, or both. The steering unit 110 may be controlled by the controller 114, the vehicle actuator 112, or both and controls the wheels 132/134/136/138 to steer the vehicle. The vehicle actuator 112 may receive signals from the controller 114 and may actuate or control the power source 106, the transmission 108, the steering unit 110, or any combination thereof to operate the vehicle 100.

In the illustrated embodiment, the controller 114 includes a location unit 116, an electronic communication unit 118, a processor 120, a memory 122, a user interface 124, a sensor 126, and an electronic communication interface 128. Although shown as a single unit, any one or more elements of the controller 114 may be integrated into any number of separate physical units. For example, the user interface 124 and the processor 120 may be integrated in a first physical unit, and the memory 122 may be integrated in a second physical unit. Although not shown in FIG. 1, the controller 114 may include a power source, such as a battery. Although shown as separate elements, the location unit 116, the electronic communication unit 118, the processor 120, the memory 122, the user interface 124, the sensor 126, the electronic communication interface 128, or any combination thereof can be integrated in one or more electronic units, circuits, or chips.

In some embodiments, the processor 120 includes any device or combination of devices, now-existing or hereafter developed, capable of manipulating or processing a signal or other information, for example optical processors, quantum processors, molecular processors, or a combination thereof. For example, the processor 120 may include one or more special-purpose processors, one or more digital signal processors, one or more microprocessors, one or more controllers, one or more microcontrollers, one or more integrated circuits, one or more Application Specific Integrated Circuits, one or more Field Programmable Gate Arrays, one or more programmable logic arrays, one or more programmable logic controllers, one or more state machines, or any combination thereof. The processor 120 may be operatively coupled with the location unit 116, the memory 122, the electronic communication interface 128, the electronic communication unit 118, the user interface 124, the sensor 126, the powertrain 104, or any combination thereof. For example, the processor may be operatively coupled with the memory 122 via a communication bus 130.

The processor 120 may be configured to execute instructions. Such instructions may include instructions for remote operation, which may be used to operate the vehicle 100 from a remote location, including the operations center. The instructions for remote operation may be stored in the vehicle 100 or received from an external source, such as a traffic management center, or server computing devices, which may include cloud-based server computing devices.

The memory 122 may include any tangible non-transitory computer-usable or computer-readable medium capable of, for example, containing, storing, communicating, or transporting machine-readable instructions or any information associated therewith, for use by or in connection with the processor 120. The memory 122 may include, for example, one or more solid state drives, one or more memory cards, one or more removable media, one or more read-only memories (ROM), one or more random-access memories (RAM), one or more registers, one or more low power double data rate (LPDDR) memories, one or more cache memories, one or more disks (including a hard disk, a floppy disk, or an optical disk), a magnetic or optical card, or any type of non-transitory media suitable for storing electronic information, or any combination thereof.

The electronic communication interface 128 may be a wireless antenna, as shown, a wired communication port, an optical communication port, or any other wired or wireless unit capable of interfacing with a wired or wireless electronic communication medium 140.

The electronic communication unit 118 may be configured to transmit or receive signals via the wired or wireless electronic communication medium 140, such as via the electronic communication interface 128. Although not explicitly shown in FIG. 1, the electronic communication unit 118 is configured to transmit, receive, or both via any wired or wireless communication medium, such as radio frequency (RF), ultra violet (UV), visible light, fiber optic, wire line, or a combination thereof. Although FIG. 1 shows a single one of the electronic communication unit 118 and a single one of the electronic communication interface 128, any number of communication units and any number of communication interfaces may be used. In some embodiments, the electronic communication unit 118 can include a dedicated short-range communications (DSRC) unit, a wireless safety unit (WSU), IEEE 802.11p (WiFi-P), or a combination thereof.

The location unit 116 may determine geolocation information, including but not limited to longitude, latitude, elevation, direction of travel, or speed, of the vehicle 100. For example, the location unit includes a global positioning system (GPS) unit, such as a Wide Area Augmentation System (WAAS) enabled National Marine Electronics Association (NMEA) unit, a radio triangulation unit, or a combination thereof. The location unit 116 can be used to obtain information that represents, for example, a current heading of the vehicle 100, a current position of the vehicle 100 in two or three dimensions, a current angular orientation of the vehicle 100, or a combination thereof.

The user interface 124 may include any unit capable of being used as an interface by a person, including any of a virtual keypad, a physical keypad, a touchpad, a display, a touchscreen, a speaker, a microphone, a video camera, a sensor, and a printer. The user interface 124 may be operatively coupled with the processor 120, as shown, or with any other element of the controller 114. Although shown as a single unit, the user interface 124 can include one or more physical units. For example, the user interface 124 includes an audio interface for performing audio communication with a person, and a touch display for performing visual and touch-based communication with the person.

The sensor 126 may include one or more sensors, such as an array of sensors, which may be operable to provide information that may be used to control the vehicle. The sensor 126 can provide information regarding current operating characteristics of the vehicle or its surroundings. The sensor 126 includes, for example, a speed sensor, acceleration sensors, a steering angle sensor, traction-related sensors, braking-related sensors, or any sensor, or combination of sensors, that is operable to report information regarding some aspect of the current dynamic situation of the vehicle 100.

In some embodiments, the sensor 126 includes sensors that are operable to obtain information regarding the physical environment surrounding the vehicle 100. For example, one or more sensors detect road geometry and obstacles, such as fixed obstacles, vehicles, cyclists, and pedestrians. The sensor 126 can be or include one or more video cameras, laser-sensing systems, infrared-sensing systems, acoustic-sensing systems, or any other suitable type of on-vehicle environmental sensing device, or combination of devices, now known or later developed. The sensor 126 and the location unit 116 may be combined.

Although not shown separately, the vehicle 100 may include a trajectory controller. For example, the controller 114 may include a trajectory controller. The trajectory controller may be operable to obtain information describing a current state of the vehicle 100 and a route planned for the vehicle 100, and, based on this information, to determine and optimize a trajectory for the vehicle 100. In some embodiments, the trajectory controller outputs signals operable to control the vehicle 100 such that the vehicle 100 follows the trajectory that is determined by the trajectory controller. For example, the output of the trajectory controller can be an optimized trajectory that may be supplied to the powertrain 104, the wheels 132/134/136/138, or both. The optimized trajectory can be a control input, such as a set of steering angles, with each steering angle corresponding to a point in time or a position. The optimized trajectory can be one or more paths, lines, curves, or a combination thereof.

One or more of the wheels 132/134/136/138 may be a steered wheel, which is pivoted to a steering angle under control of the steering unit 110; a propelled wheel, which is torqued to propel the vehicle 100 under control of the transmission 108; or a steered and propelled wheel that steers and propels the vehicle 100.

A vehicle may include units or elements not shown in FIG. 1, such as an enclosure, a Bluetooth® module, a frequency modulated (FM) radio unit, a Near-Field Communication (NFC) module, a liquid crystal display (LCD) display unit, an organic light-emitting diode (OLED) display unit, a speaker, or any combination thereof.

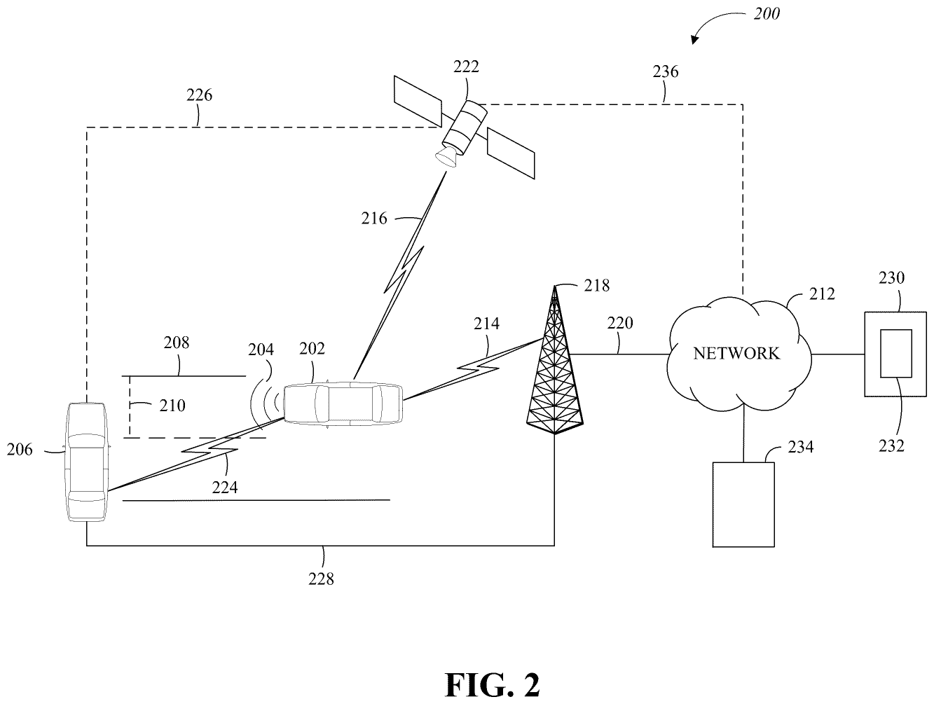

FIG. 2 is a diagram of an example of a portion of a vehicle transportation and communication system 200 in which the aspects, features, and elements disclosed herein may be implemented. The vehicle transportation and communication system 200 includes a vehicle 202, such as the vehicle 100 shown in FIG. 1, and one or more external objects, such as an external object 206, which can include any form of transportation, such as the vehicle 100 shown in FIG. 1, a pedestrian, cyclist, as well as any form of a structure, such as a building. The vehicle 202 may travel via one or more portions of a transportation network 208, and may communicate with the external object 206 via one or more of an electronic communication network 212. Although not explicitly shown in FIG. 2, a vehicle may traverse an area that is not expressly or completely included in a transportation network, such as an off-road area. In some embodiments, the transportation network 208 may include one or more of a vehicle detection sensor 210, such as an inductive loop sensor, which may be used to detect the movement of vehicles on the transportation network 208.

The electronic communication network 212 may be a multiple access system that provides for communication, such as voice communication, data communication, video communication, messaging communication, or a combination thereof, between the vehicle 202, the external object 206, and an operations center 230. For example, the vehicle 202 or the external object 206 may receive information, such as information representing the transportation network 208, from the operations center 230 via the electronic communication network 212.

The operations center 230 includes a controller apparatus 232, which includes some or all of the features of the controller 114 shown in FIG. 1. The controller apparatus 232 can monitor and coordinate the movement of vehicles, including autonomous vehicles. The controller apparatus 232 may monitor the state or condition of vehicles, such as the vehicle 202, and external objects, such as the external object 206. The controller apparatus 232 can receive vehicle data and infrastructure data including any of: vehicle velocity; vehicle location; vehicle operational state; vehicle destination; vehicle route; vehicle sensor data; external object velocity; external object location; external object operational state; external object destination; external object route; and external object sensor data.

Further, the controller apparatus 232 can establish remote control over one or more vehicles, such as the vehicle 202, or external objects, such as the external object 206. In this way, the controller apparatus 232 may teleoperate the vehicles or external objects from a remote location. The controller apparatus 232 may exchange (send or receive) state data with vehicles, external objects, or a computing device, such as the vehicle 202, the external object 206, or a server computing device 234, via a wireless communication link, such as the wireless communication link 226, or a wired communication link, such as the wired communication link 228.

The server computing device 234 may include one or more server computing devices, which may exchange (send or receive) state signal data with one or more vehicles or computing devices, including the vehicle 202, the external object 206, or the operations center 230, via the electronic communication network 212.

In some embodiments, the vehicle 202 or the external object 206 communicates via the wired communication link 228, a wireless communication link 214/216/224, or a combination of any number or types of wired or wireless communication links. For example, as shown, the vehicle 202 or the external object 206 communicates via a terrestrial wireless communication link 214, via a non-terrestrial wireless communication link 216, or via a combination thereof. In some implementations, a terrestrial wireless communication link 214 includes an Ethernet link, a serial link, a Bluetooth link, an infrared (IR) link, an ultraviolet (UV) link, or any link capable of electronic communication.

A vehicle, such as the vehicle 202, or an external object, such as the external object 206, may communicate with another vehicle, external object, or the operations center 230. For example, a host, or subject, vehicle 202 may receive one or more automated inter-vehicle messages, such as a basic safety message (BSM), from the operations center 230 via a direct communication link 224 or via an electronic communication network 212. For example, the operations center 230 may broadcast the message to host vehicles within a defined broadcast range, such as three hundred meters, or to a defined geographical area. In some embodiments, the vehicle 202 receives a message via a third party, such as a signal repeater (not shown) or another remote vehicle (not shown). In some embodiments, the vehicle 202 or the external object 206 transmits one or more automated inter-vehicle messages periodically based on a defined interval, such as one hundred milliseconds.

The vehicle 202 may communicate with the electronic communication network 212 via an access point 218. The access point 218, which may include a computing device, is configured to communicate with the vehicle 202, with the electronic communication network 212, with the operations center 230, or with a combination thereof via wired or wireless communication links 214/220. For example, an access point 218 is a base station, a base transceiver station (BTS), a Node-B, an enhanced Node-B (eNode-B), a Home Node-B (HNode-B), a wireless router, a wired router, a hub, a relay, a switch, or any similar wired or wireless device. Although shown as a single unit, an access point can include any number of interconnected elements.

The vehicle 202 may communicate with the electronic communication network 212 via a satellite 222 or other non-terrestrial communication device. The satellite 222, which may include a computing device, may be configured to communicate with the vehicle 202, with the electronic communication network 212, with the operations center 230, or with a combination thereof via one or more communication links 216/236. Although shown as a single unit, a satellite can include any number of interconnected elements.

The electronic communication network 212 may be any type of network configured to provide for voice, data, or any other type of electronic communication. For example, the electronic communication network 212 includes a local area network (LAN), a wide area network (WAN), a virtual private network (VPN), a mobile or cellular telephone network, the Internet, or any other electronic communication system. The electronic communication network 212 may use a communication protocol, such as the Transmission Control Protocol (TCP), the User Datagram Protocol (UDP), the Internet Protocol (IP), the Real-time Transport Protocol (RTP), the Hyper Text Transport Protocol (HTTP), or a combination thereof. Although shown as a single unit, an electronic communication network can include any number of interconnected elements.

In some embodiments, the vehicle 202 communicates with the operations center 230 via the electronic communication network 212, access point 218, or satellite 222. The operations center 230 may include one or more computing devices, which are able to exchange (send or receive) data from a vehicle, such as the vehicle 202; data from external objects, including the external object 206; or data from a computing device, such as the server computing device 234.

In some embodiments, the vehicle 202 identifies a portion or condition of the transportation network 208. For example, the vehicle 202 may include one or more on-vehicle sensors 204, such as the sensor 126 shown in FIG. 1, which includes a speed sensor, a wheel speed sensor, a camera, a gyroscope, an optical sensor, a laser sensor, a radar sensor, a sonic sensor, or any other sensor or device or combination thereof capable of determining or identifying a portion or condition of the transportation network 208.

The vehicle 202 may traverse one or more portions of the transportation network 208 using information communicated via the electronic communication network 212, such as information representing the transportation network 208, information identified by one or more on-vehicle sensors 204, or a combination thereof. The external object 206 may be capable of all or some of the communications and actions described above with respect to the vehicle 202.

For simplicity, FIG. 2 shows the vehicle 202 as the host vehicle, the external object 206, the transportation network 208, the electronic communication network 212, and the operations center 230. However, any number of vehicles, networks, or computing devices may be used. In some embodiments, the vehicle transportation and communication system 200 includes devices, units, or elements not shown in FIG. 2.

Although the vehicle 202 is shown communicating with the operations center 230 via the electronic communication network 212, the vehicle 202 (and the external object 206) may communicate with the operations center 230 via any number of direct or indirect communication links. For example, the vehicle 202 or the external object 206 may communicate with the operations center 230 via a direct communication link, such as a Bluetooth communication link. Although, for simplicity, FIG. 2 shows one of the transportation network 208 and one of the electronic communication network 212, any number of networks or communication devices may be used.

The external object 206 is illustrated as a second, remote vehicle in FIG. 2. An external object is not limited to another vehicle. An external object may be any infrastructure element, for example, a fence, a sign, a building, etc., that has the ability transmit data to the operations center 230. The data may be, for example, sensor data from the infrastructure element.

As mentioned initially, observed drivelines may be used together with available (e.g., road-level) map data to create data-based driveline maps with lane-level details. Next described are the data used to create a data-based driveline map and a process or method for creating and using a data-based driveline map.

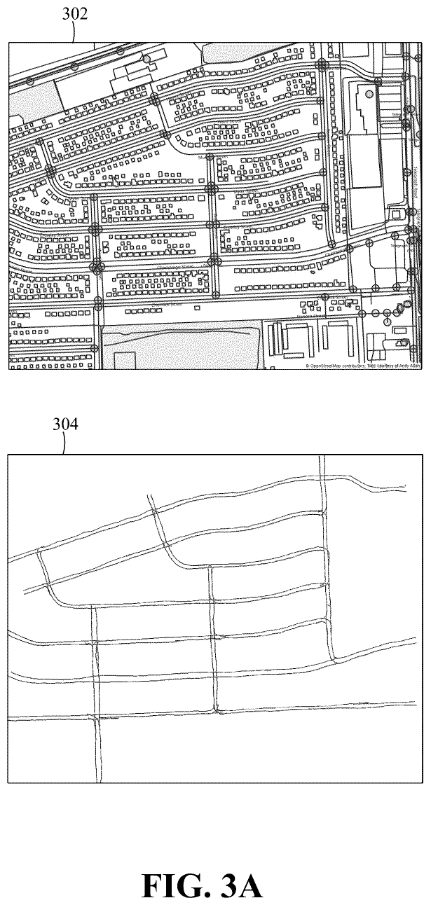

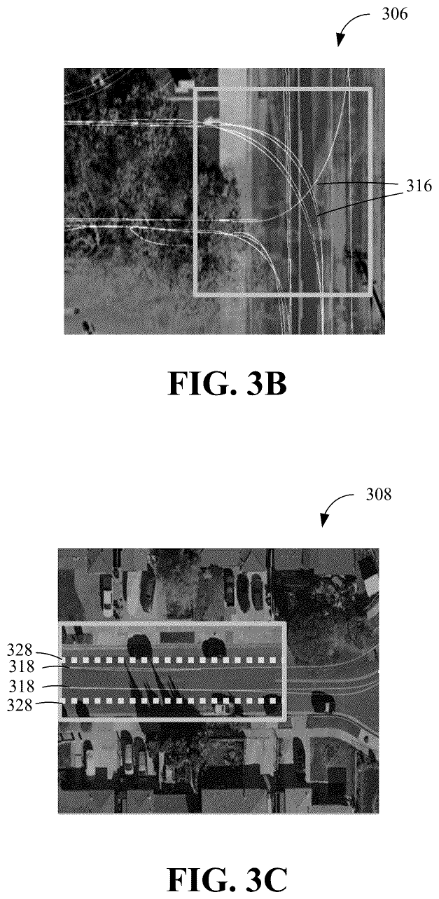

FIG. 3A shows examples of map data in accordance with the present disclosure. An example of road-level map data is shown. The road-level map data depicts a portion 302 of a mapped area. In the road-level map data, the roads 304 are mapped at the road level. In the portion 302, however, lane-level mapping based on geometric centerlines is shown for illustrative purposes.

FIG. 3B is a diagram showing an example of observed drivelines in a portion 306 of a vehicle transportation network, and FIG. 3C is a diagram showing an example of observed drivelines 316 and ways in a portion 306 of a vehicle transportation network.

In FIG. 3B, the portion 306 illustrates drivelines 316 of multiple observed vehicles, such as the vehicle 202 of FIG. 2, collected while the vehicles were making turns within the vehicle transportation network. A driveline contains a series of poses, where a pose represents a specific point location and heading of the vehicle as it was traversing the vehicle transportation network. Driveline data includes one or more drivelines.

In FIG. 3C, a portion 308 illustrates drivelines 318 of multiple observed vehicles, such as the vehicle 202 of FIG. 2, collected while the vehicles are driving along a residential street within the vehicle transportation network. Road-level map data includes way data, the way data containing one or more ways. A way represents a lane or a road. Each way contains a series of nodes in which each node represents a specific point location and heading of the way. The example of FIG. 3C shows a bi-directional way without lane markings. Points 328 in FIG. 3C are shown at the geometric centerline for each direction of travel. As can be seen from comparing the drivelines 318 to the points 328, drivers rarely drive on the geometric centerline for each direction.

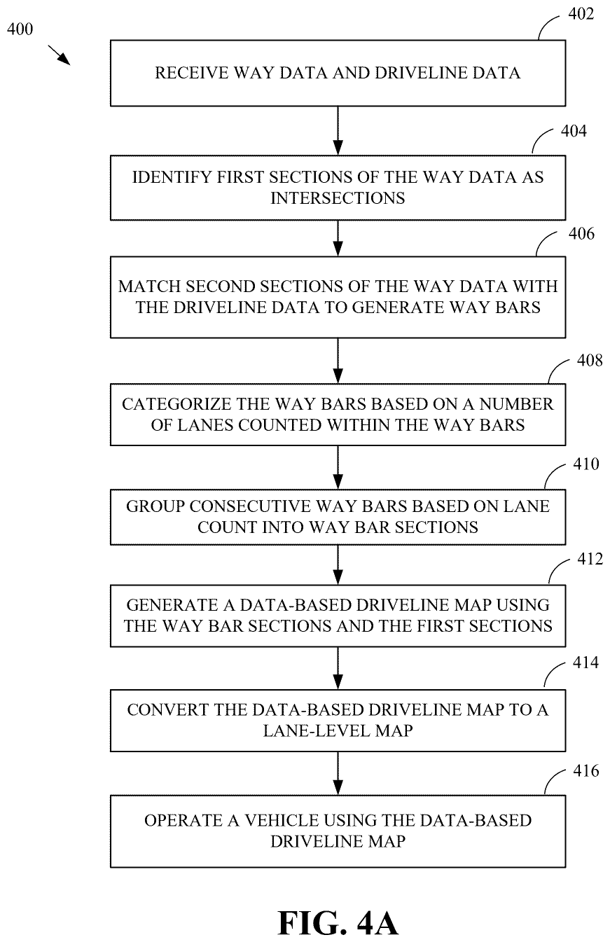

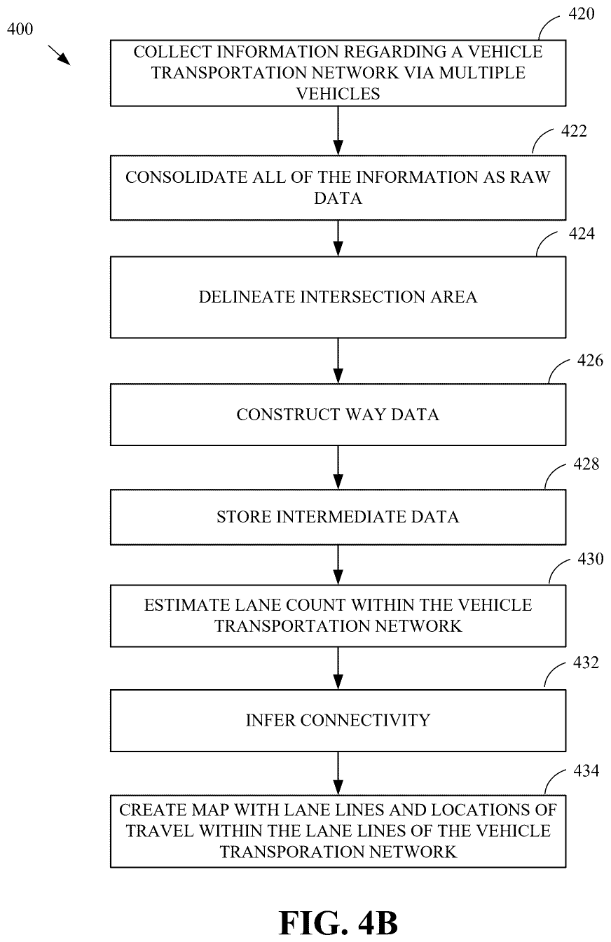

FIG. 4A includes a flowchart diagram of a method or process 400 for generating a data-based driveline map in accordance with the present disclosure. The process 400 includes operations 402 through 416, which are described below. The process 400 can be stored in a memory (such as the memory 122 of FIG. 1) as instructions that can be executed by a processor (such as the processor 120 of FIG. 1) of an AV (such as the vehicle 100 of FIG. 1). Some or all operations of the process 400 may be performed at a remote support center for vehicle, such as by the controller apparatus 232 at the operations center 230.

At operation 402, the process 400 receives, as inputs, road-level map data as described above in relation to the road-level map data of FIG. 3A and observed driveline data as described above in relation to the observed driveline data of FIGS. 3B and 3C. The road-level map data may be received from an existing source such as OpenStreetMap (OSM) or another open street map-like source. Note that some roads within the road-level map data may have lane-level data.

The observed driveline data may be received from another vehicle such as the vehicle 202 of FIG. 2 traversing the vehicle transportation network or the observed driveline data may be generated by the host vehicle. The observed driveline data may be received from operations center 230 in which the data was stored by one or more vehicles previously traversing the vehicle transportation network.

At operation 404, the process 400 identifies first sections of the way data, received with the road-level map data, as intersections. The identified intersections are portions of the vehicle transportation network in which multiple ways of the road-level data intersect or cross. The intersections may be identified by nodes that belong to more than one way. An individual way within the road-level map data includes a series of nodes that may be determined via the geometrical lane center, as described above in FIG. 3C. However, each node can belong to more than one way. When a section of the way data is identified as containing nodes that overlap may belong to more than one way, that section is identified as an intersection. The overlap of multiple nodes may indicate that vehicles traveling along different directions cross a location within the vehicle transportation network indicating that an intersection is present.

At operation 406, the process 400 matches second sections of the way data with the received driveline data to generate way bars. The way bars may be spaced a predetermined distance apart. The way bars may be generated at predetermined distances along the driveline (e.g., about 2 m apart). The first sections are different from the second sections. More specifically, concurrently with or after determining which sections of the way data are categorized as intersections, the process 400 may match the observed driveline data with the road-level map data to generate way bars. A way bar is a grouping of poses from separate drivelines of the driveline data associated with a node of a way included in the way data of the road-level map data. The node of the way may be an actual node within the way data or the node may be interpolated from the way data. A node that has been interpolated may be interpolated from two actual nodes on either side of the interpolated node. For each pair of consecutive actual nodes there may be many interpolated nodes. Each interpolated node is associated with the same way as the actual nodes in which it has been interpolated from. For example, a way bar is a cross section of the way and driveline data wherein each pose within the way bar is associated with a different driveline and the node in the way bar is associated with a single way.

FIG. 4B includes a flowchart diagram of a method or process 400 for estimating a road structure to generate a drive map so that a vehicle moves within a vehicle transportation network. The process 400 includes operations 420 through 432, which are described below. The process 400 can be stored in a memory (such as the memory 122 of FIG. 1) as instructions that can be executed by a processor (such as the processor 120 of FIG. 1) of an AV (such as the vehicle 100 of FIG. 1). Some or all operations of the process 400 may be performed at a remote support center for a vehicle, such as by the controller apparatus 232 at the operations center 230. Some or all of the operations of the process 400 may be performed in parallel, in series, at a same time, on a same day, spaced apart, delayed, or a combination thereof.

At operation 420, information is collected regarding the vehicle transportation network. The information collected relates to one or more vehicles. The information collected may relate to multiple vehicles (e.g., 2 or more, 5 or more, 10 or more, or even 25 or more vehicles). The information collected at operation 420 may relate to vehicle positions, timing of vehicle movement, position of vehicles within a lane, the vehicle transportation network, or any combination thereof. The information may be collected as raw data. The information may be collected and stored. The information collected may be overlayed over the OSM. The information collected may be from the OSM, sensors on one vehicle, sensors on multiple vehicles, a vehicle sensing adjacent vehicles, or a combination thereof. During operation 420, after operation 420, or both the information may be consolidated in operation 422.

At the operation 422, the collected information may be consolidated as raw data. Consolidation of the information may based upon a vehicle, a time, a lane within the vehicle transportation network, a direction of travel, a driveline, a pattern of travel, or a combination thereof. Consolidation of the information may include any data that is collected in real time. After consolidation of the information, the consolidated information may be saved as raw data.

At operation 424, the raw data is analyzed to delineate an intersection area within the vehicle transportation network. An intersection area may be delineated by determining a change in direction. An intersection may be delimited via drivelines changing shape, changing direction, changing direction along a way bar, changing a location where the vehicle crosses the way bars, or a combination thereof. The intersection may be determined by some drivelines crossing, a turn in ways, or both. The intersection may include drivelines that are not linear.

At operation 426, way data may be constructed. The way data may be constructed based on drivelines. The way data may be reviewed to determine lanes within the vehicle transportation network. The way data may be constructed at each way bar to determine a location where vehicles cross the way bars. The constructed way data may determine a node for each lane, each way bar, each direction of travel, or a combination thereof. The constructed way data may be constructed on a way bar by way bar basis to generate nodes at each way bar. The way data from multiple vehicles may be consolidated together as way data, to form a node, or both. The way data may be constructed and checked by matching way data to OSM data. The way data may be checked by performing multiple types of matching or instances of matching.

At operation 428, consolidated way data may be stored as intermediate data. The intermediate data may be stored without any manipulation. The intermediate data may be stored based on time, location, way bar, or a combination thereof. The intermediate data may be stored for analysis at a later time. The intermediate data may be sorted but not analyzed. Once the intermediate data is stored the intermediate data is analyzed offline (e.g., not in real time).

At operation 430, lanes within the vehicle transportation network may be estimated. The lanes may be estimated based upon the intermediate data. The operation 430 may be performed offline. The lanes may be estimated based upon the way data at each way bar. The lanes may be estimated based upon nodes. The lanes may be estimated based upon a direction of travel, an average crossing-location of a way bar, or both. The lanes may be estimated based upon a frequency of crossing at a location of the way bar.

At operation 432, the nodes may be connected so that connectivity of the vehicle transportation network may be inferred. For example, by connecting the nodes outliers may be determined, outliers may be deleted or discarded, lanes may be determined, intersections may be determined, or a combination thereof. The operation 432 may be performed offline. The connectivity may assist in producing a line that a vehicle will travel along through the vehicle transportation network. The connectivity may connect node to node illustrating a travel location of a vehicle within the vehicle transportation network. The connectivity may be checked or reviewed on a lane-by-lane basis. Once the nodes are connected the connected nodes may be placed within the vehicle transportation network.

At operation 434, a map is created that includes lane lines, locations of travel by a vehicle, the vehicle location within a lane line, locations of intersections, locations of changing lines, or a combination thereof. The map may be created based on nodes or lane lines. The lane lines may be superimposed over an OSM. The lane lines may be placed within the OSM to generate a location of travel with each lane of the vehicle transportation network. The operation 434 may be performed offline. The lane lines may indicate substantially a center of each lane within the vehicle transportation network. The map may include a location where a vehicle travels along each lane such that as a vehicle travels within a lane of the map, the vehicle avoids vehicles within adjacent lanes. The map may be updated over time as more data is collected. Once the intermediate data is stored at operation 428, operations 430, 432, and 434 may be performed in parallel, in series, two at a time, or any combination thereof.

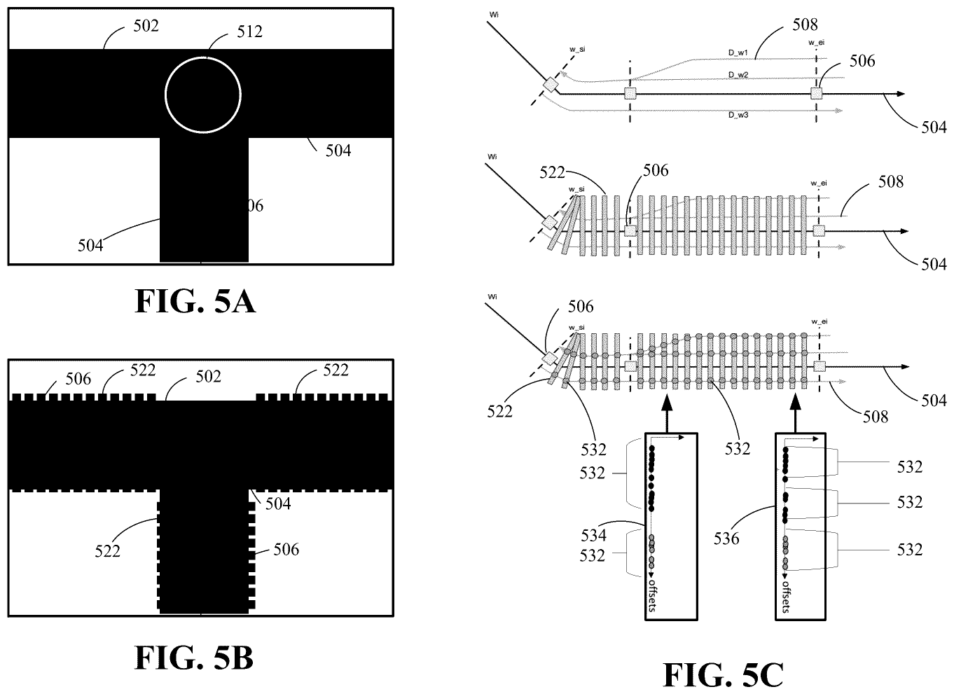

FIG. 5A-5C are diagrams of an example of identifying intersections and matching road-level map data with observed driveline data. The example depicts a portion of the vehicle transportation network, namely a roadway 502, ways 504 such as those included within the way data of the road-level map data, nodes 506 of the series of nodes of the ways, and drivelines 508 such as the drivelines included in the observed driveline data.

FIG. 5A illustrates a portion of the road-level map data where more than one way 504 intersect. An intersection 512 is identified by nodes 506 that are overlapping as well as nodes 506 that belong to more than one way 504. The intersection 512 may be one of the intersections identified at operation 404 of the process 400.

FIG. 5B illustrates how way bars 522 relate to ways 504 and their nodes 506. A way bar 522 is oriented perpendicular to a way 504 such that a way bar 522 may represent a width or span of the corresponding lane of the vehicle transportation network. A way bar 522 is a collection of poses associated with drivelines of the observed driveline data. In addition, a way bar 522 contains a node 506 that is associated with a way 504 from the way data. The node 506 as well as the collection of poses contained within a way bar 522 are all related to the same position longitudinally along a lane of a road within the vehicle transportation network.

FIG. 5C illustrates the orientation of drivelines 508 from observed driveline data to ways 504, as well as the series of nodes 506 included within a driveline 508. For example, there might be more than one driveline 508 observed for a given way 504. The way 504 can have multiple nodes 506 contained within the series of nodes for the way 504. The drivelines 508 include a series of poses 532, The poses 532 correspond to a node 506 of a way 504. These corresponding poses 532, nodes 506, or both are grouped together to create a way bar 522.

Additionally, while three drivelines 508 are depicted in FIG. 5C, as shown in a first way bar 534 and a second way bar 536, there can be more, or fewer poses associated with more or fewer drivelines 508. Furthermore, the drivelines 508 can be spaced at various intervals or offsets from the node 506 contained within the way bar 522. The poses 532 with the first way bar 534 and the second way bar 536 are a plurality of locations where vehicles cross each of the respective way bars 534, 536. As shown, the poses 532 are grouped together indicating that multiple lanes are present (e.g., two in way bar 534 and three in way bar 536).

Together, FIGS. 5B and 5C illustrate matching second sections of the way data with the received driveline data to generate way bars as described with regards to operation 406.

Referring again to FIG. 4, at operation 408, the way bars are categorized based on a cardinality (e.g., a number) of lanes counted within the way bars. That is, for the way bars generated as part of the operation 406, the operation 408 determines the number of lanes represented with the way bar. The number of lanes may be counted based on the one or more poses contained with the way bar and the distance of each pose from the next closest pose within the way bar.

For the operation 408 to determine the number of lanes, the one or more poses of the way bar are first grouped according to the directionality of the pose. For example, each pose within the way bar corresponds to a point location and contains a heading. The heading is used to determine the directionality of the pose. Poses with the same heading are grouped. For example, the poses that contain a heading indicating a direction of east will be grouped separately from the poses that contain a heading indicating a direction of west. See for example, the grouping of the poses 532 within the first way bar 534 and the second way bar 536.

After the poses are grouped according to the directionality of the pose, an offset may be defined for the poses. The offset represents the distance between the pose and the node of the way bar. After the offsets are determined the poses within each group are sorted by the offsets. For example, a group of poses all with the directionality of east might contain three nodes. Each of the three nodes within the group will have an offset defined based on the distance of that poses from the node. Specifically, if the node is at position 0 within the way bar, and a first poses is at position 0.3, the offset for the first pose is 0.3. Similarly, if the distance between a second poses and the node is 0.2, the offset for the second poses is 0.2. This same process is repeated for the remaining poses within the way bar. For this example, the first pose, the second pose and a third pose would have the respective offsets of 0.3, 0.2 and 0.35. The poses would then be sorted based on the offsets. The resulting order of the poses in this example is the second pose, the first pose, and the third pose.

After the poses have been sorted based on the defined offsets, the distance between the poses is determined based on the sort order. Continuing the example where the poses are ordered as the second pose, the first pose, and the third pose, a first distance between the second pose and the first pose is calculated, then a second distance between the first and third pose is calculated.

The distances calculated may then be compared to a new lane threshold value. If the first distance is greater than the new lane threshold value, then the lane count may be incremented. Additionally, if the first distance is less than the new lane threshold and greater than a same lane threshold, the lane count may be characterized as unknown. This process may then be repeated for each distance calculated in this manner until all the distances have been evaluated against the new lane threshold and the same lane threshold.

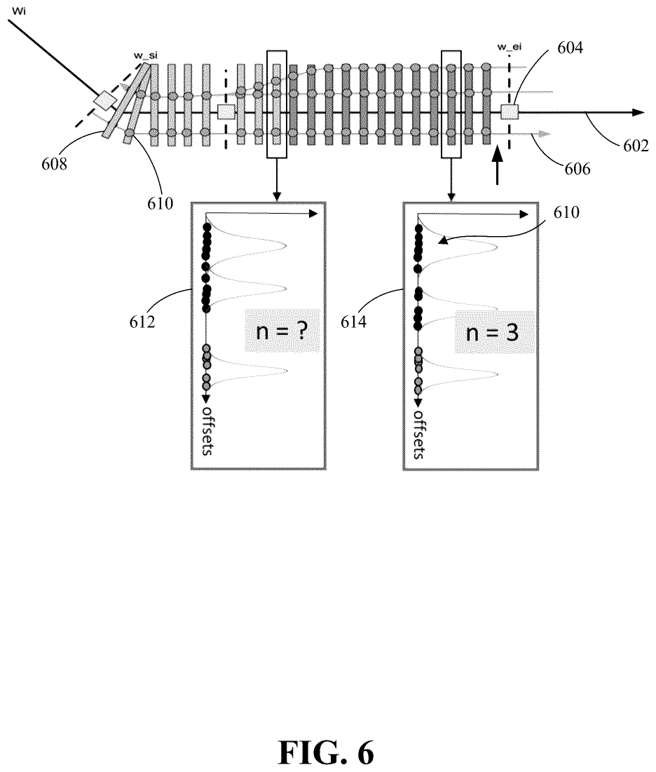

FIG. 6 is an example of how the lane counts are calculated. FIG. 6 shows a way 602, nodes 604, drivelines illustrating the way direction) 606, way bars 608, and poses 610. Additionally, a first way bar 612 depicts an instance where the lane count is categorized as unknown. For example, the first way bar 612 contains several poses. The poses have been grouped according to directionality and sorted based on the defined offsets of the poses, e.g., such as using any appropriate clustering technique. In the top group of poses, there is no defined grouping of poses. In other words, the distances between each of the poses is greater than the same lane threshold but less than the new lane threshold. As such, the lane count is categorized as unknown. In this example, the same lane threshold is equal to 0.55 meters and the new lane threshold is equal to 2.2 meters; however, the threshold values may be set to any appropriate values.

While the first way bar 612 depicts two separate groups based on directionality and one may infer that there are at least 2 lanes, the fact that the distances calculated between the poses contained within the directionality groupings are all between the new lane threshold and the same lane threshold indicates that there is most likely a change in the number of lanes for this way bar. For example, the way bar may represent a transition from a two-lane road to a three-lane road or vice versa. Because the total number of lanes cannot be determined, the lane count is categorized as unknown for the entire first way bar 612.

Furthermore, a second way bar 614 depicts an instance where the lane count is determined to be 3. The poses 610 have been grouped according to directionality and sorted based on the offsets of the poses. In contrast to the first way bar 614, both the top group and the bottom group have a clearly defined grouping of poses. That is, the calculated distance between the poses contained within the group based on directionality are all either calculated to be less than the same lane threshold or greater than the new lane threshold. This allows the process 400 to determine a total lane count of 3 for the second way bar 614.

Referring again to FIG. 4, process 400 groups consecutive way bars into way bar sections based on the lane count assigned at operation 410. That is, each consecutive way bar is compared to the neighboring way bars. For example, the lane count of way bars depicted in a horizonal alignment are compared with the way bar to the left and right of the given way bar, whereas for way bars depicted in a vertical alignment may have the lane count compared with lane count of the way bar above and below the given way bar. While the way bars are depicted in a horizontal or vertical alignment, way bars may be aligned in any orientation so long as they are perpendicular to the corresponding way with which the way bar is associated.

In a further example, referring again to FIG. 6, the depicted way bars 608 may be grouped into 3 sections. The first section contains the way bar 608 shown to the left of the image having a lane count of 2. The second section contains the way bars 608 shown in the center of the image with a lane count categorized as unknown (like the example of the first way bar 612). The third section contains the way bars 608 to the right of the image with a lane count equal to 3 (like the example of the second way bar 614).

Referring again to FIG. 4, a data-based driveline map is generated at operation 412 using the way bar sections and the first sections. The way bar sections may be assigned a link node to a beginning of the way bar section and an end of the way bar section. Once the way bar sections have a link node assigned to the beginning of the way bar section and the end of the way bar section, driveline nodes are assigned corresponding to the associated drivelines of the poses contained in the first way bar and last way bar of each section.

The link nodes assigned to the way bar sections may be used to determine how a first way bar section may connect to a second way bar section and/or to a third way bar section. The way bar section may be connected using the link nodes and/or a first section (i.e., an intersection).

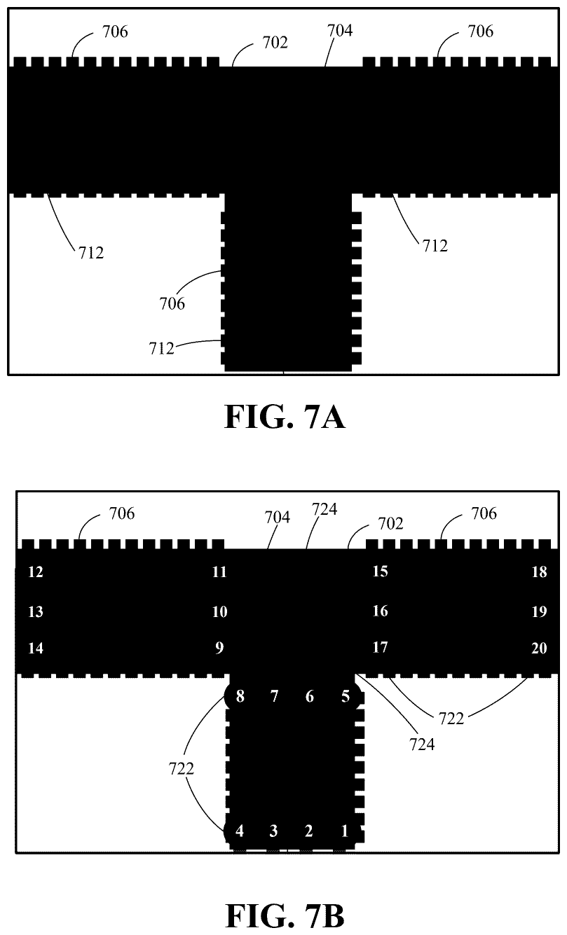

FIGS. 7A and 7B may be used to explain the operation 412.

FIG. 7A is diagram of an example of assigning link nodes. This example depicts a portion of a vehicle transportation network, namely a roadway 702, along with ways 704 and way bars 706. Link nodes 712 link different sections of the road (such as lane-count-change sections, constant lane sections, and intersections), e.g., using the start/end bars of ways. For example, link nodes 712 may be assigned to the beginning and the end of the way bar sections relative to the way direction (see also FIG. 6). For example, if a vehicle is attempting to navigate from LN6 (i.e., the right-most edge of FIG. 7A) to LN1 (i.e., the bottom-most edge of FIG. 7A), the sequence of link nodes would be LN6→LN5→LN2→LN1. Alternatively, if the vehicle is attempting to navigate from LN1 (i.e., the bottom-most edge of the view 700) to LN4 (i.e., the left-most edge of the view 700) the sequence of nodes would be LN1→LN2→LN3→LN4. As such any path through the vehicle transportation network can be conveyed as a series of link nodes 712.

Once a sequence of link nodes 712 has been defined, the driveline nodes 722 of FIG. 7B are used to determine the actual paths (i.e., routes, courses, etc.) used to traverse the portion of the vehicle transportation network. This is also referred to as inferring driveline connectivity. Driveline nodes 722 are created at the bars with link modes 712 and link the drivelines 724 in respective driveline directions.

For example, continuing with the examples from above, if a vehicle is navigating from LN6 to LN1, the sequence of link nodes 712 may be LN6→LN5→LN2→LN1. A driveline that navigates this sequence of link nodes 712 follows a sequence of driveline nodes 722 labeled DN19→DN16→DN7→DN3. This is but one possible way that a vehicle may traverse the vehicle transportation network to get from LN6 to LN1. For example, another sequence of driveline nodes that navigates this sequence of link nodes 712 is labeled DN19→DN16→DN8→DN4. The remaining paths may be similarly inferred from drivelines 724.

Referring again to FIG. 4, the data-based driveline map is converted into a lane-level map at operation 414. To use the data-based driveline map to plan a trajectory for a vehicle, such as the vehicle 100 of FIG. 1, additional map properties may be useful. Properties such as speed limits and lane properties are useful when planning a trajectory for a vehicle. The lane properties can be inferred based on the observed driveline data from drive node to drive node, such as the driveline nodes 722 of FIG. 7. Speed limit data may be obtained from the road-level map data received at operation 402. For example, the way type in an OSM may be used to initially set a speed. The speed limit data may come from any other source. For example, the vehicle 100 might receive the speed limit data as a part of the road-level map data of the portion 302 of FIG. 3. Alternatively, the speed limit data may be received from the operation center 230 or the server computing device 234 via the electronic communication network 212 of FIG. 2. Lane relationships (successor/predecessor) may be inferred from the drive node sequences. Sibling/opposite lanes may be defined according to the relative positions of lanes. Crossing lanes and/or crossing points for intersections may be identified.

At operation 416, the process 400 uses the data-based driveline map as input to a control system of a vehicle to operate the vehicle. The vehicle may be the vehicle 100. The control system may be implemented using the controller 114 from FIG. 1. For example, the data-based driveline map may be received by the controller 114 in response to a request to travel from a first place to a second place. The controller 114 may use the data-base driveline map to efficiently determine the best route to travel from the first place to the second place. More specifically, the controller may use the data-base driveline map to determine the sequence of link nodes 712 and then the sequence of driveline nodes 722 from FIG. 7. After the sequence of driveline nodes 722 have been determined, the controller 114 may plan a trajectory for the vehicle to traverse the vehicle transportation network. The data-based driveline map may also be used as input into specific control systems. For example, the map may be used in a trajectory controller for assisted braking, assisted steering, or some combination thereof.

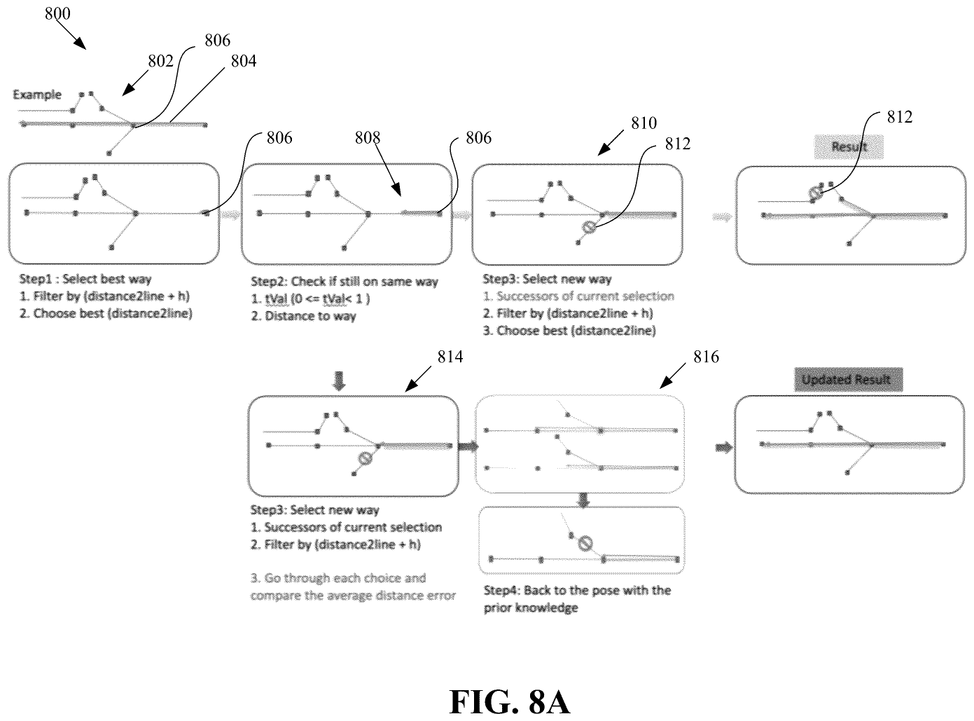

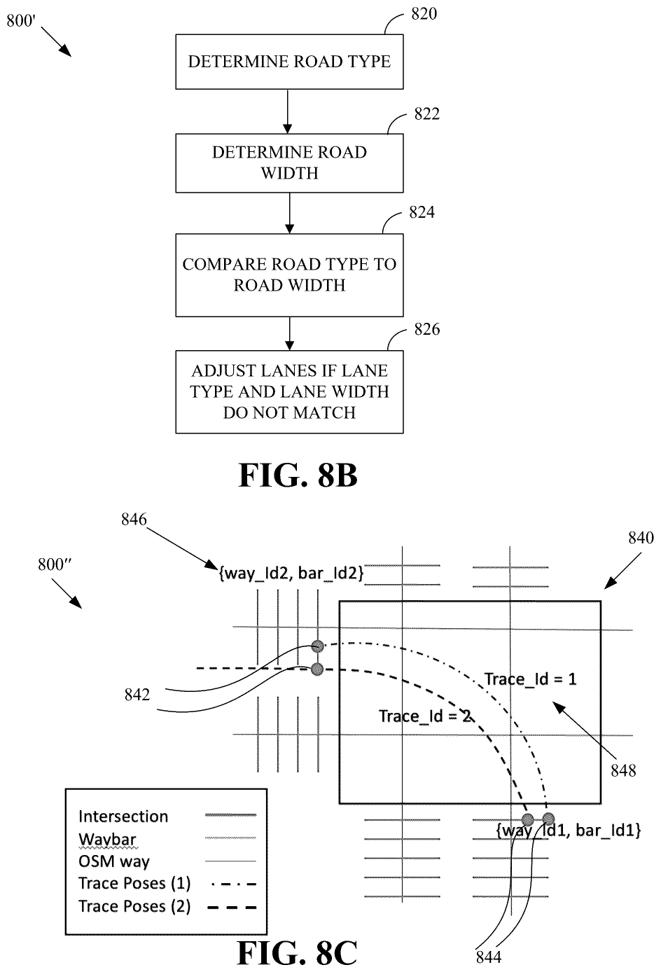

FIG. 8A illustrates a process 800 of matching data to determine way data and maybe even lane data. The process begins at operation 802 where an example driving location 804 is generated based upon the way data, nodes, or both. The way data, nodes, or both may have some points that are located outside of the driving location 804. The drive location 804 of operation 802 may then be checked to determine if the drive location is accurately placed within a lane (e.g., a way 504 within a lane).

At operation 806, which may be a first step, a first node or best way is selected. The best way may be selected based upon comparing the nodes or the way data to the OSM. The best way (e.g., the way closest to the center of a lane) may be selected based upon a highest concentration of way data. The best way may be selected based upon a distance to the first side line, the second side line, or both (e.g., a distance between a first line, a second line, or both). The ways may be filtered to select ways that are closest to a center of a lane. The best way and a first node may be selected based upon a center of concentration of the way data. The best way, node, or both may be selected based on a distance from center (e.g., such as way 504 shown in FIG. 5) based upon the lane lines. The best way (e.g., node) may selected by filtering, choosing a distance between lane lines, or both. The best way may be selected and then as a vehicle continues traveling, the route may continue to be checked as the vehicle travels away from the best way.

At operation 808, which may be a second step, the path/route of the vehicle is checked to determine if the vehicle is still on a same way, aligned with the best way, aligned with a node, or a combination thereof. The route of the vehicle may be compared continuously to a distance from the lane lines, a distance from the center, a distance from the center of the prior node/best way, or a combination thereof. The vehicle may be monitored as the vehicle travels away from the best way (e.g., first way). A distance from the best way and the vehicle is monitored so that the path of the vehicle is tracked and may be followed by subsequent vehicles. The operation 808 may be performed until the vehicle is a predetermined distance from a previous way (e.g., a first way).

At operation 810, which may be a third step, a new node and/or new best way may be selected. The new best way (e.g., a second way) may be saved. The new best way may be selected by filtering out other ways similar to the filtering of the best way in operation 806. The filtering may be based upon a distance from a lane line, both lane lines, a center of a lane, or a combination thereof. Once all of the ways are filtered the best way at that location may be chosen. The best way may be compared to a predecessor best way and/or node and, if available, to a subsequent best way and/or node. Thus, ways may be eliminated such that a drive route extends down a center of a lane without the vehicle traveling through the eliminated ways 812.

Alternatively, at operation 814, a third step may be performed, to choose subsequent nodes and/or best ways. The operation 814 may select a new best way and/or node (e.g., a second node, a third node, etc.). All of the ways may be reviewed and a new best way and/or a new node may be selected by reviewing all respective values of the nodes, filtering all of the nodes, or both based upon a distance from lane lines, a distance from center, or both. A new best way, a new node, or both may be selected by reviewing each way based upon a distance error, an average of every way, an average distance error of every way, or a combination thereof. The distance error may be determined based upon a center of a lane from the OSM, a distance between lane lines, a distance from drive path of a prior node, a subsequent node, or both. The average distance error may be based upon a distance from a line that connects a prior node and a subsequent node that extends through and/or past the new best way and/or new node. Once the node with the lowest average distance error is selected the node may be reviewed.

At operation 816, the current node may be reviewed based upon a prior node and a subsequent node in view of prior knowledge (e.g., poses previously collected). In comparing the current node to the prior node, the line that extends through the current node may illustrate outliers (e.g., adjacent lanes, turn lanes, intersections, movements outside of a center of a lane). For example, any way that is located outside of the line connecting the prior node and subsequent node may be considered an outlier and thus ignored. Therefore, a line along substantially a center of a line is plotted so that a vehicle may travel down a center of the lane.

FIG. 8B is a process 800′ of performing a second type of matching. The second type of matching further assists in maintaining a vehicle within a lane (e.g., such that the vehicle travels along a way). The second type of matching assists in maintaining a vehicle within a center (e.g., along a way that extends within a road) of a lane as lane types, lane widths, or both change while the vehicle traverses the vehicle transportation network. The process 800′ of the second type of matching may ensure that a lane is not of a different size of that being considered such that a center of the lane is inaccurately determined based upon an incorrect lane width.

At operation 820, the road type may be determined. The road type may be determined based upon information from an OSM. The road type may be determined based upon a speed of a vehicle on that road, a speed limit on that road, user input, or a combination thereof. The road type (e.g., way) may be a highway, a country road, a residential road, an industrial road, or a combination thereof.

At operation 822, a road width may be determined. The road width may be determined based upon information from an OSM. The road width may be about 5 m or more, about 7 m or more, or about 9 m or more. The road width may be about 20 m or less, about 15 m or less, or about 10 m or less. For example, a residential road may be 9 m wide, and a highway may be 15 m wide.

At operation 824, the road type and the road width may be compared to determine if they match. If the road width and the road type match, then the matching step is complete. If the road width and the road type do not match, then the process moves to operation 826. For example, if the operation 820 determines that the road is a residential road and the operation 822 determines that the road width is 9 m, then the road type and road width do not match. Generally, a highway is about 15 m wide, and a residential road is about 9 m wide.

At operation 826, the width is adjusted to ensure that a correct lane width is used to determine a center of the lane. The lane width may be determined based on the OSM and the system updated. The lane width may be reviewed to determine if the vehicle is located on a way. Thus, by identifying a correct lane width, the vehicle may be directed substantially down a center of a lane within the vehicle transportation network.

FIG. 8C is a process 800″ of performing a third type of matching. The process 800″ determines a route through an intersection 840 from an entrance 842 to an exit 844.

At operation 846, poses are recorded at the entrance 842 and poses are recorded at the exit 844. The poses are locations where a vehicle enters and exits the intersection 840. The poses at the entrance 842 and the exit 844 are then connected to form a path through the intersection 840. The poses at the entrance 842 and the poses at the exit 844 may be recording on the way bars and subsequently used to generate a path through the intersection. The poses are then compared to a heading threshold. The heading threshold may be determined from a GPS, Global Navigation Satellite System (GNSS), OSM, or a combination thereof. The poses at the entrance 842 and the exit 844 are compared (e.g., matched) to determine if the poses match. The poses are recorded at each way bar and if the poses at the entrance 842 and the exit 844 match then the poses are used to form a path from way bar to way bar through the intersection.

At operation 848, matching may be performed to determine if the poses match a heading threshold. The heading threshold may be a difference between a location from the GPS, GNSS, OSM, or a combination thereof, and the poses determined from drive lines of vehicles passing through the intersection. If the poses match the heading threshold (e.g., OSM way), then the poses may be used to determine where a vehicle enters and exits the intersection. If the poses and the heading threshold do not match, then only the heading threshold may be used. For example, the heading threshold information from the GPS, GNSS, OSM, or a combination thereof may be more accurate than the poses and may be used in place of the poses. Alternatively, if the threshold information is more recent than the poses, the threshold information may be used until additional or newer poses are collected.

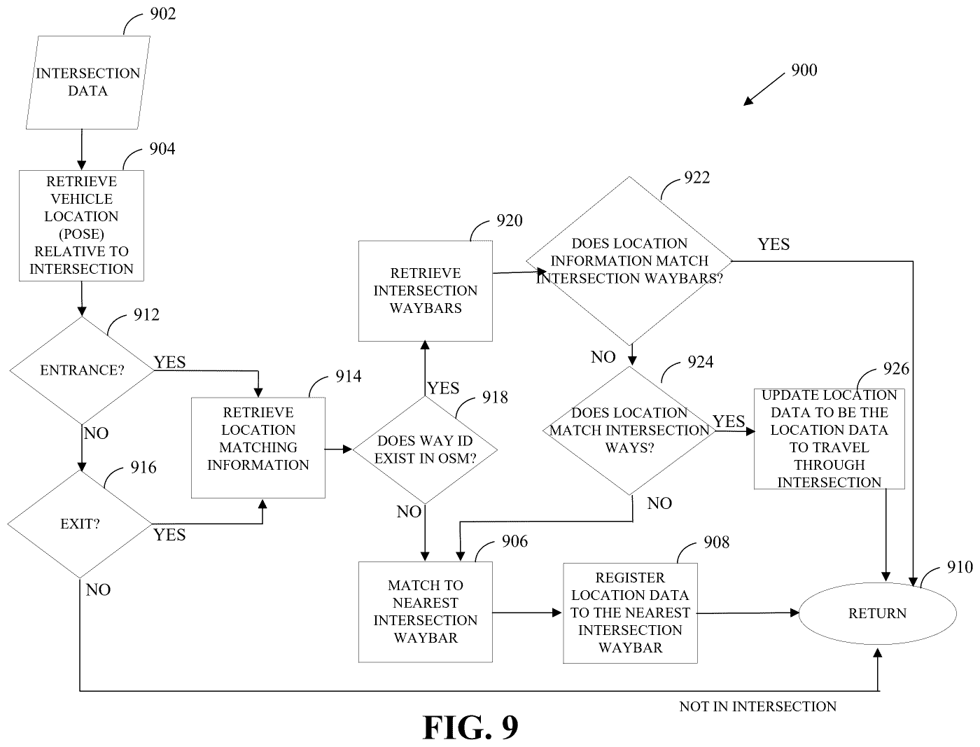

FIG. 9 illustrates a process 900 of matching data (e.g., poses to an ID from OSM). The process 900 may be performed entirely offline. The process 900 begins by performing an operation 902 to retrieve intersection data. The intersection data may be the next intersection, all intersections within a radius, intersections along a route, intersections along a plotted course, intersections along a perceived course based upon prior courses, or a combination thereof. The intersection data may be locations within a coordinate system (e.g., X and Y or longitude and latitude). The intersection data may include entrances, exits, or both. The intersection data may include all of the entrances and all of the exits and locations connecting each of the entrances and each of the exits.

At operation 904, a current vehicle location (e.g., pose) may be retrieved. The current vehicle location may be determined relative to an intersection, an entrance of an intersection, an exit of an intersection, or any combination thereof. The information retrieved may be the next intersection, surrounding intersections, a possible next intersection, or any combination thereof. The information retrieved may be relative to a way bar closest to the intersection such as the way bar at the entrance 842 and the way bar at the exit 844 shown in FIG. 8C. The information may be retrieved so that operation 904 may be performed offline. The poses at each of these way bars are determined and then the traces extend there through to assist in determining how a vehicle will travel through the intersection. However, if no intersection is approaching, then retrieving the information of operation 904 may be skipped and process may go to operation 910.

At operation 910, the intersection may be cleared by the vehicle or an intersection may not be present, and the process 900 may return back to operation 902 so that the process 900 may be repeated for a next intersection.

Returning to operation 904, if an intersection is approaching or the vehicle is entering the intersection, then the process 900 moves to operation 912.

At operation 912, an entrance of the intersection is determined. If the vehicle is in or entering the entrance, then the process 900 proceeds to operation 914. If the vehicle is past the entrance, is not entering the entrance, or both, then the process proceeds to operation 916.

At operation 916, if the vehicle is approaching an exit or is in an exit, then the process 900 proceeds to operation 914. However, if the vehicle is not within the entrance, approaching the entrance, within the exit, or approaching the exit, then the process 900 proceeds to operation 910 and the process 900 is not performed.

At operation 914, matching results are retrieved to determine if the poses match at the intersection. At operation 914, locations of the entrance of the intersection from operation 912 are compared, locations from the exit of the intersection from operation 916 are compared, or both. By comparing the locations from operation 912 to one another, the process 900 determines whether the locations match, if there are overlapping locations (e.g., poses), or both. The location matching may determine a location where a vehicle enters the intersection, exits the intersection, or both. The location matching may be an average of a collection of locations where a vehicle passes into the entrance, out of the exit, or both. For example, if 100 locations were collected for the entrance or exit, then the average passing locations of the vehicle may be generated and matched to one another. Operation 914 may double-check poses to determine if the poses match results at the intersection in order to generate a drive location through the intersection. Once a location is matched (e.g., selected), this location may indicate an initial drive location of a vehicle.

At operation 918, the OSM is checked to see if the intersection is present (e.g., the intersection has an identification (Way ID) in the OSM). The Way ID of the intersection may include locations of the entrances, the exits, or both. The Way ID may include coordinates of the intersection. The Way ID may include coordinates for each lane, each entrance, each exit, a center of the intersection, or any combination thereof. The Way ID may identify a center of each lane, a center of each entrance, a center of each exit, or any combination thereof. If an ID exists in the OSM, then operation 920 is performed next. If the ID of the intersection does not exist in the OSM, then operation 906 is performed next.

At operation 906, data regarding an intersection may be compared to a vehicle location (e.g., where the vehicle was located at a time of interest) regarding the intersection. The intersection data and intersection way bar data may be compared to see if the intersection information match. The intersection way bar data may not be from an OSM as the Way ID was not found to exist in the OSM. The intersection way bar data may be from a GPS, GNSS, or any combination of both. The intersection data may be compared to intersection way bar data. The intersection way bar data and the vehicle location data may be compared.

At operation 908, the poses (e.g., vehicle positions within an intersection) may be updated with vehicle information once the vehicle passes through the intersection. The position where a vehicle passes through an intersection from an entrance to an exit may be updated, registered, or both. The position (e.g., poses) where the vehicle passes through the intersection may be used for positions where the vehicle passes through the intersections. The positions may be updated in real time (e.g., as they are subsequently generated offline), after a predetermined number of additional poses are collected (e.g., 100 or more, 1,000 or more, or even 10,000 or more), or both. The positions through the intersection may be updated and/or registered on a first in first out basis once a predetermined number of poses are collected, a predetermined amount of time has passed, or both.

At operation 920, the identified information regarding the intersection may be retrieved (e.g., Way ID). The intersection information (Way ID) may include coordinates, locations relative to way bars, entrance data, exit data, lane information, or a combination thereof. The intersection information may be based on GPS data, GNSS data, or both, and may be stored in the OSM. The intersection information from the OSM may include a width of a lane, a location of a beginning of an intersection, a location of an exit of the intersection, where vehicles pass through the intersection, or any combination thereof. The intersection information may be retrieved for each way bar.

At operation 922, the OSM information (e.g., Way ID) is compared to the location information (e.g., poses) from the vehicle. If the OSM information and the location information from the vehicle match, then the information is used for that intersection to control vehicles through the intersection while operation 910 returns to the beginning of the matching process 900. Stated another way, if the Way ID and the poses match then the way bar locations are used and the process begins again. However, if at operation 922 the OSM information and the location information of the vehicle do not match then the matching process 900 performs operation 924.

At operation 924, the precise location information (e.g., poses) is compared to the identification information (e.g., coordinates or Way ID). The location information (e.g., poses) at each way bar is compared to location information from the OSM (e.g., the Way ID). If the location information from the vehicle does match the location information from the OSM then operation 926 is performed to update the location data from the vehicle to control the vehicle through the intersection. If the location information of the vehicle and the location information from the OSM do not match at operation 924, then operations 906 and 908 described above are used to provide location information to control the vehicle through the intersection. The location information from the OSM may not track human driving patterns or position; thus, the position data may be updated vial the poses so that how the vehicle drives through the intersection is updated to more accurately extend through the intersection at a location where a user would drive through the intersection. In either case, operation 910 returns to the beginning of the matching process 900.

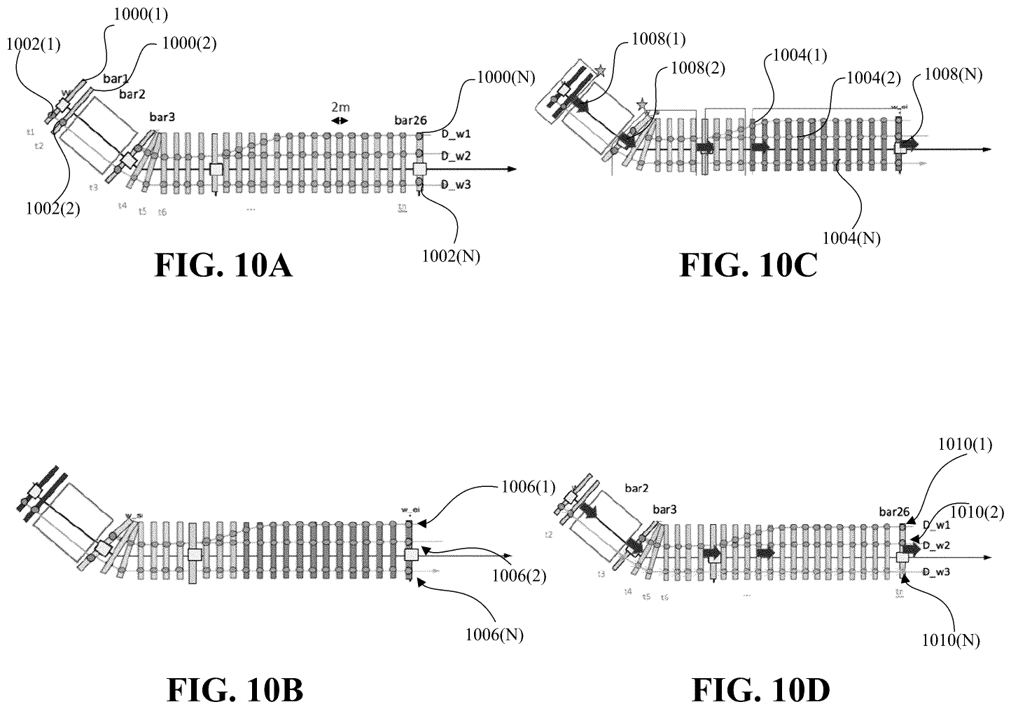

FIG. 10A illustrates collecting data from a database to determine a vehicle drive location along a road such as an intersection. The query from the database includes a plurality of way bars 1000(1), 1000(2), . . . 1000(N). The database may be acquired offline. The way bars 1000 are equally spaced apart along a roadway. At each way bar 1000 a plurality of data points (e.g., poses) are collected. The poses are then compiled to generate nodes 1002(1), 1002(2), . . . 1002(N) illustrating substantially a center of each line at each way bar 1000.

FIG. 10B illustrates estimating the number of lanes 1006(1), 1006(2), . . . 1006(N) based upon the location of the nodes 1002 on each way bar 1000 of FIG. 10A.

FIG. 10C illustrates connecting the nodes 1002 on each way bar 1000 of FIG. 10A to illustrate substantially drive locations 1008(1), 1008(2), . . . 1008(N). The drive locations 1008 estimate a drive location.

FIG. 10D illustrates each of the vehicle drive locations 1010(1), 1010(2), . . . 1010(N) within a lane. Thus, the vehicle drive locations 1010 within each lane 1006 are identified such that a later vehicle will travel along the vehicle drive locations 1010.

For simplicity of explanation, the techniques herein are depicted and described as a series of operations. However, the operations in accordance with this disclosure can occur in various orders and/or concurrently. Additionally, other steps or operations not presented and described herein may be used. Furthermore, not all illustrated operations may be required to implement a technique in accordance with the disclosed subject matter.

As used herein, the terminology “driver” or “operator” may be used interchangeably. As used herein, the terminology “brake” or “decelerate” may be used interchangeably. As used herein, the terminology “computer” or “computing device” includes any unit, or combination of units, capable of performing any method, or any portion or portions thereof, disclosed herein.

As used herein, the terminology “instructions” may include directions or expressions for performing any method, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, or combinations thereof, as described herein. In some implementations, instructions, or a portion thereof, may be implemented as a special-purpose processor or circuitry that may include specialized hardware for carrying out any of the methods, algorithms, aspects, or combinations thereof, as described herein. In some implementations, portions of the instructions may be distributed across multiple processors on a single device, or on multiple devices, which may communicate directly or across a network, such as a local area network, a wide area network, the Internet, or a combination thereof.

As used herein, the terminology “example,” “embodiment,” “implementation,” “aspect,” “feature,” or “element” indicate serving as an example, instance, or illustration. Unless expressly indicated otherwise, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “determine” and “identify,” or any variations thereof, includes selecting, ascertaining, computing, looking up, receiving, determining, establishing, obtaining, or otherwise identifying or determining in any manner whatsoever using one or more of the devices shown and described herein.

As used herein, the terminology “or” is intended to mean an inclusive “or” rather than an exclusive “or.” That is, unless specified otherwise or clearly indicated otherwise by the context, “X includes A or B” is intended to indicate any of the natural inclusive permutations thereof. If X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from the context to be directed to a singular form.

Further, for simplicity of explanation, although the figures and descriptions herein may include sequences or series of operations or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and/or elements.

While the disclosed technology has been described in connection with certain embodiments, it is to be understood that the disclosed technology is not to be limited to the disclosed embodiments but, on the contrary, is intended to cover various modifications and equivalent arrangements included within the scope of the appended claims, which scope is to be accorded the broadest interpretation as is permitted under the law so as to encompass all such modifications and equivalent arrangements.

What is claimed is:

1. A method, comprising:
receiving information about vehicles traveling within a vehicle transportation network, wherein:
the information comprises driveline data and information regarding lanes within the vehicle transportation network, and
the driveline data comprises one or more drivelines representing a position of one of the vehicles as the vehicle traverses the vehicle transportation network;
consolidating all of the information as raw data;
delineating an intersection area from the information about the vehicle transportation network;
constructing way data from the information about the vehicle transportation network;
storing intermediate data comprising the information, the intersection area, and the way data;
estimating a number of the lanes within the vehicle transportation network based on the way data; and
inferring a drive location with the lanes based on the way data; and
creating a map that includes the lanes, the drive location within the lanes, and the intersection area within the vehicle transportation network.

2. The method of claim 1, wherein an intersection including the intersection area is identified by identifying nodes that correspond to the way data.

3. The method of claim 1, further comprising:
determining a road type for each of the lanes;
matching a sensed lane width with a lane width from a database; and
adjusting the lane width if the sensed lane width and the lane width from the database do not match.

4. The method of claim 3, further comprising:
filtering the way data;
selecting a way from the way data that is a best way and is located closest to the drive location of the lane; and
checking the drive location as a distance from the best way changes and a location approaches a subsequent way location.

5. The method of claim 4, further comprising:
selecting the subsequent way location from the way data as a subsequent best way.

6. The method of claim 5, further comprising:
checking each way;
determining an average distance error for each way; and
eliminating one of the drive locations that does not align with the best way, the subsequent best way, or both.

7. The method of claim 1, further comprising:
retrieving intersection data;
determining if an intersection is approaching;
determining a vehicle location relative to an entrance of the intersection as the vehicle enters; and
determining a vehicle location relative to an exit of the intersection.

8. The method of claim 7, further comprising:
comparing the vehicle location at the entrance to a vehicle location retrieved from an open street map (OSM).

9. An apparatus, comprising:
a memory; and
a processor configured to execute instructions stored in the memory to:
receive information about vehicles traveling within a vehicle transportation network, wherein:
the information comprises driveline data and information regarding lanes within the vehicle transportation network, and
the driveline data comprises one or more drivelines representing a position of one of the vehicles as the vehicle traverses the vehicle transportation network;
consolidate all of the information as raw data;
delineate an intersection area from the information about the vehicle transportation network;
construct way data from the information about the vehicle transportation network;
store intermediate data comprising the information, the intersection area, and the way data;
estimate a number of the lanes within the vehicle transportation network based on the way data;
infer a drive location with the lanes based on the way data; and
create a map that includes the lanes, the drive location within the lanes, and the intersection area within the vehicle transportation network.

10. The apparatus of claim 9, wherein the processor is configured to execute instructions stored in the memory to:
check the way data constructed by performing one or more instances of matching.

11. The apparatus of claim 10, wherein an instance of the matching comprises to:
determine a width of one of the lanes within the vehicle transportation network; and
compare the width to a width of the lane from an open street map (OSM).

12. The apparatus of claim 11, wherein the width of the one of the lanes from the vehicle transportation is provided if the width from the OSM and the width of the lanes from the vehicle transportation network do not match.

13. The apparatus of claim 9, wherein the processor is configured to execute instructions stored in the memory to:
filter the way data so that a way is selected to determine a drive location through a lane; and
subsequently filter the way data so that a subsequent way is selected to determine a subsequent drive location through the lane.

14. The apparatus of claim 13, wherein the processor is configured to execute instructions stored in the memory to:
determine if the drive location matches a location from an open street map (OSM) to determine if the drive location extends substantially down a center of the lane.

15. The apparatus of claim 9, wherein the processor is configured to execute instructions stored in the memory to:
determine an intersection and then locate poses at an entrance of the intersection, at an exit of the intersection, or both; and
compare the poses to location information from an open street map (OSM) to determine if the poses match the location information for the exit, the entrance, or both so that a drive location through the intersection is ascertained.

16. A non-transitory computer-readable medium storing instructions operable to cause one or more processors to perform operations to:
receive information about vehicles traveling within a vehicle transportation network, wherein:
the information comprises driveline data and information regarding lanes within the vehicle transportation network, and
the driveline data comprises one or more drivelines representing a position of one of the vehicles as the vehicle traverses the vehicle transportation network;
consolidate all of the information as raw data;
delineate an intersection area from the information about the vehicle transportation network;
construct way data from the information about the vehicle transportation network;
store intermediate data comprising the information, the intersection area, and the way data;
estimate a number of the lanes within the vehicle transportation network based on the way data; and
infer a drive location with the lanes based on the way data; and
create a map that includes the lanes, the drive location within the lanes, and the intersection area within the vehicle transportation network.

17. The non-transitory computer-readable medium of claim 16, wherein to estimate the number of lanes, to infer the drive location, and to create the map are performed offline by a processor of the one or more processors.

18. The non-transitory computer-readable medium of claim 16, wherein to estimate the number of lanes comprises to estimate the number of lanes at each way bar along the drive location within the lane of the vehicle transportation network.

19. The non-transitory computer-readable medium of claim 18, wherein the instructions include instructions to compare the number of the lanes, the drive location within the lanes, or both to location information from an open street map (OSM).

20. The non-transitory computer-readable medium of claim 19, wherein the instructions include instructions to:
determine a width of the lanes based upon the way data;
retrieve a width of the lanes from the location information from the OSM; and
compared the width determined to the width from the OSM.
